(19) United States
(12) Patent Application Publication
(10) Pub. No.: US 2009/0188396 A1
(43) Pub. Date: Jul. 30, 2009

(54) OVEN WITH WIRELESS TEMPERATURE SENSOR FOR USE IN MONITORING FOOD TEMPERATURE

(76) Inventors: Matthias C. Hofmann, Blacksburg, VA (US); Jessica N. Long, Kettering, OH (US); Jon K. Engelsman, West Lafayette, IN (US); Qian Yang, Dayton, OH (US); Jacob D. Wahl, Columbus, OH (US); Brian Smith, Kettering, OH (US); Michael D'Fantis, Fairlawn, OH (US); John Holchin, Manchester, CT (US)

Correspondence Address: Thompson Hine LLP, 2000 Courthouse Plaza N.E., 10 W. Second Street, Dayton, OH, 45402-1758, US

(21) Appl. No.: 12/186,309

(22) Filed: Aug. 5, 2008

Related U.S. Application Data
(60) Provisional application No. 60/954,191, filed on Aug. 6, 2007.

(51) Int. Cl. A47J 37/04; G05D 23/20; G01K 7/00

(52) U.S. Cl. 99/342; 99/421 H; 219/494; 374/163; 374/E07.001

(57) ABSTRACT

An oven includes a housing including a heating chamber. A door has an open position for allowing operator access to the heating chamber and a closed position for preventing user access to the heating chamber. A heating system heats a food product located within the heating chamber. A wireless temperature sensor is configured to be inserted into the food product by an operator for measuring food product temperature and to provide a wireless signal indicative of food product temperature. An oven control system includes a sensor communicator for receiving the temperature indicative signal from the wireless temperature sensor. The oven control system operates in response to the wireless signal.

### CROSS-REFERENCE TO RELATED APPLICATIONS

This application claims priority to U.S. Provisional Patent Application No. 60/954,191, filed Aug. 6, 2007, which is hereby incorporated by reference as if fully set forth herein.

### TECHNICAL FIELD

This application relates generally to ovens for cooking food and, more particularly, to such an oven with a wireless temperature sensor.

### BACKGROUND

Various types of ovens are used for cooking food product. Rotisserie ovens are commonly used in commercial food service and food retail environment to cook chickens and other food products in a manner that permits viewing the food product during cooking. The ovens use convection and radiant heating for cooking and can hold up to 30 or more chickens or other types of meat.

### SUMMARY

In an aspect, an oven includes a housing including a heating chamber. A door has an open position for allowing operator access to the heating chamber and a closed position for preventing user access to the heating chamber. A heating system heats a food product located within the heating chamber. A wireless temperature sensor is configured to be inserted into the food product by an operator for measuring food product temperature and to provide a wireless signal indicative of food product temperature. An oven control system includes a sensor communicator for receiving the temperature indicative signal from the wireless temperature sensor. The oven control system operates in response to the wireless signal.

In another aspect, a wireless temperature sensor for use in ovens includes a probe end and an opposite end. A wireless transmitter transmits a temperature indicative signal. A thermobattery (or thermopile) provides power to the wireless transmitter and includes a cold sink at or proximate to the probe end and a hot sink positioned at or proximate to the opposite end.

In another aspect, a passive wireless temperature sensor includes a probe end and an opposite end. A resonant circuit includes a temperature sensitive component located toward a probe end of the wireless temperature sensor such that a resonant frequency of the circuit varies with temperature of the food product.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of an embodiment of a rotisserie oven;

FIG. 2 is a perspective view of another embodiment of a rotisserie oven;

FIG. 3 is a diagrammatic, section view of an embodiment of a rotisserie oven;

FIG. 4 is a diagrammatic view of the rotisserie oven of FIG. 1 during a cooking operation;

FIG. 5 is a diagrammatic illustration of an embodiment of a tag including a temperature sensitive component for use in measuring temperature of a food product during a cooking operation;

FIG. 6 is a diagrammatic representation of communication between a tag and a reader;

FIGS. 7 and 8 are a diagrammatic illustrations of an embodiment of a tag and temperature sensor for use in measuring temperature of a food product during a cooking operation;

FIG. 9 is a diagrammatic illustration of a system for measuring temperature of a number of food products during a cooking operation.

### DETAILED DESCRIPTION

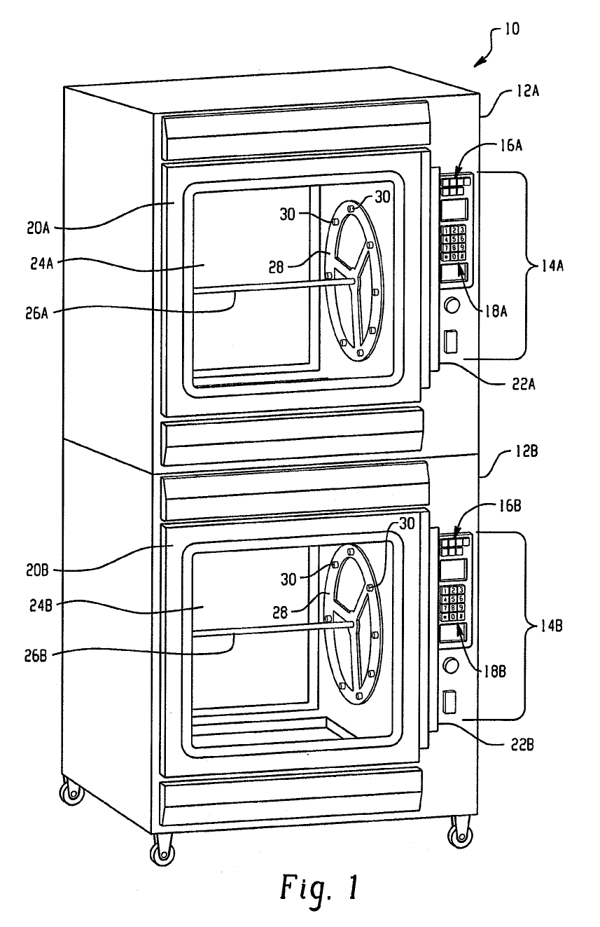

Referring to FIG. 1, a rotisserie oven 10 includes an upper rotisserie oven 12A stacked on top of a lower rotisserie oven 12B. Each rotisserie oven 12A and 12B includes a respective control interface 14A and 14B, which may include a variety of components, such as an informational display area 16A and 16B, a numeric keypad input 18A and 18B, On/Off buttons, function specific keys and/or various indicator lights. Each oven includes a vertically hinged access door 20A and 20B with a handle 22A and 22B and glass front viewing panel 24A and 24B for viewing the rotisserie operation. The rear side of the ovens 12A and 12B may also include a viewing window, which in some embodiments, is part of a rear door.

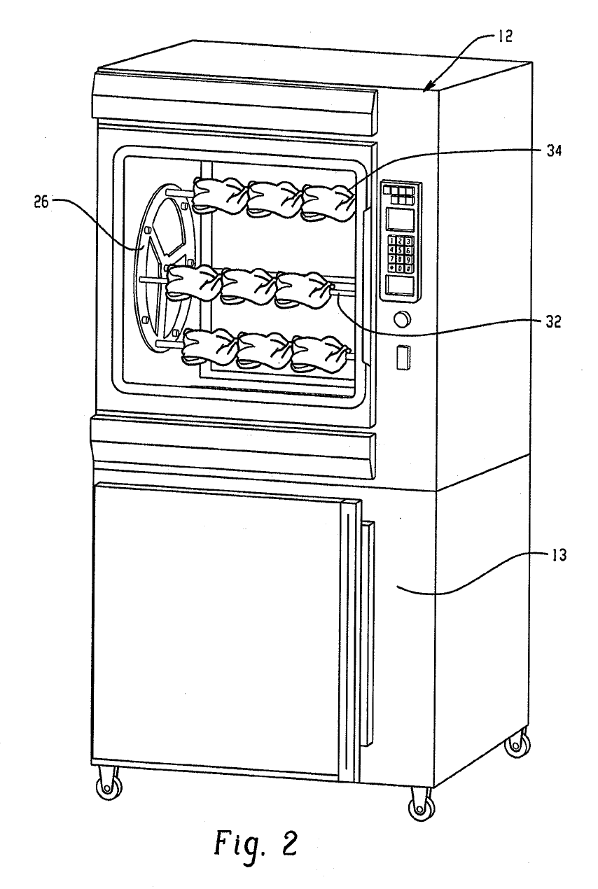

A rotisserie rotor 26A and 26B is located within the heating chamber of each rotisserie oven 12A and 12B. The rotisserie rotors 26A and 26B are each driven by a motor, which rotates the rotisserie rotors 26A and 26B at desired rate. Each rotisserie rotor 26A and 26B includes a wheel 28 that includes a number of support members 30 extending outwardly from an inwardly facing surface of the wheel. Referring briefly to FIG. 2 illustrating another embodiment of a rotisserie oven 12 located on a cabinet 13, each of the support members 30 can be used to support a spit 32, which are used to support a food product thereon (e.g., chickens 34) as the rotisserie rotors 26 rotate during cooking. In some embodiments, each rotisserie rotor 26 can support up to 30 chickens or more for a cooking operation. An exemplary suitable rotisserie oven is an HR or KA Series Rotary Oven, commercial available from Hobart Corporation, Troy, Ohio.

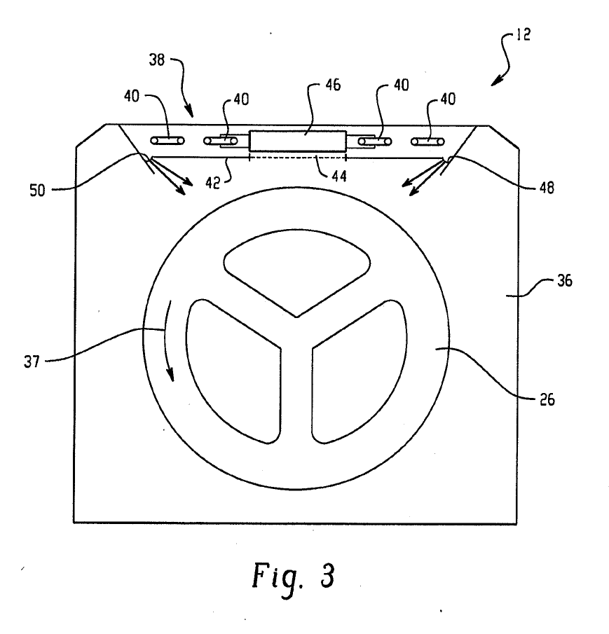

FIG. 3 is a side, diagrammatic view of an exemplary heating chamber 36 of the rotisserie oven 12 including rotisserie rotor 26. During a cooking operation, the rotisserie rotor 26 rotates (see arrow 37) and heat is generated by heating system 38. In the illustrated embodiment, the heating system 38 is formed by heating elements 40 located above an upper plate or shield 42. The shield 42 includes one or more intake openings 44 with associated convection fans 46 arranged to draw air into the openings 44 from the heating chamber 36 and to push air forward and rearward across the heating elements 40 to pick up heat before the heated air is directed back into the heating chamber at forward and rearward slots 48 and 50. The space above shield 42 may include various directional plates or baffles to produce a desired air flow.

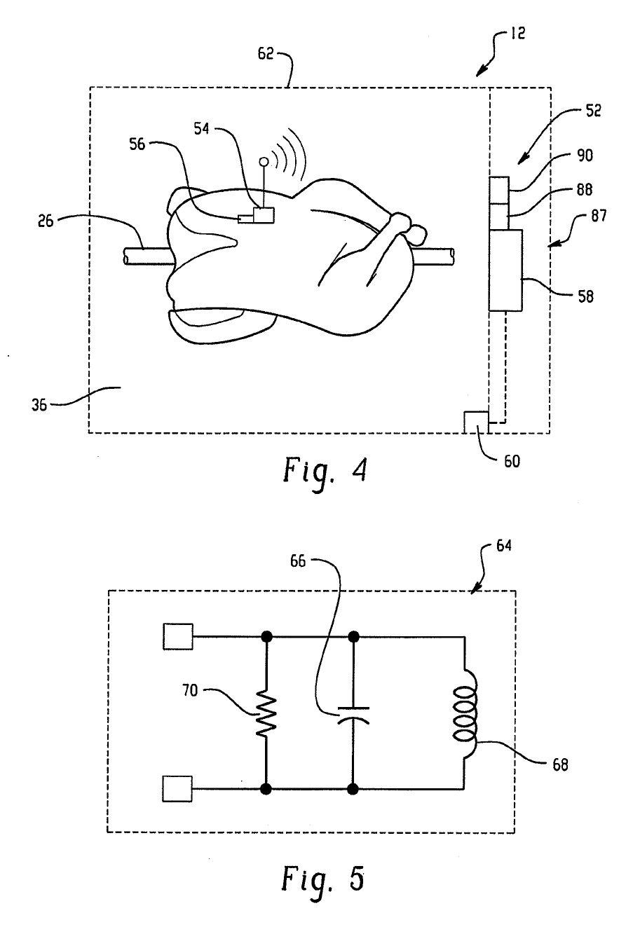

Referring to FIG. 4, the rotisserie oven 12 includes an automatic temperature measurement acquisition system (generally referred to as element 52) that is used to monitor the internal temperature of the food products. The automatic temperature measurement acquisition system 52 includes a wireless transmitter 54 (transmitter/receiver or transponder equipped to send and receive energy at selected electromagnetic frequencies) and temperature sensor 56 that is integrated with or located near the wireless transmitter. The wireless transmitter 54 transmits temperature indicative signals generated using the temperature sensor to a sensor communicator (e.g., reader 58). The reader includes an antenna 60 capable of receiving the wireless signal from the wireless transmitter 54. In some embodiments, the reader 58 and antenna 60 may be incorporated within the rotisserie oven 12, as shown. For example, the reader 58 may located in the oven housing 62 (but outside the heating chamber 36) and the antenna 60 may be connected to the door 20 (FIG. 1) or elsewhere within or on the rotisserie oven 12. In some embodiments, the reader 58 and/or antenna 60 may be separate from the rotisserie oven 12.

In one embodiment, the wireless transmitter and temperature sensor may be incorporated into a radio-frequency (RF) tag 64 that resonates at a frequency based on an LCR circuit built into the tag. Referring to FIG. 5, the tag 64 including the LCR circuit includes a capacitor 66, an inductor 68 and a thermistor 70 that varies the resonant frequency based on temperature in a fashion that correlates with food product temperature by locating the thermistor 70 (e.g., such as a thermistor probe) within the food product.

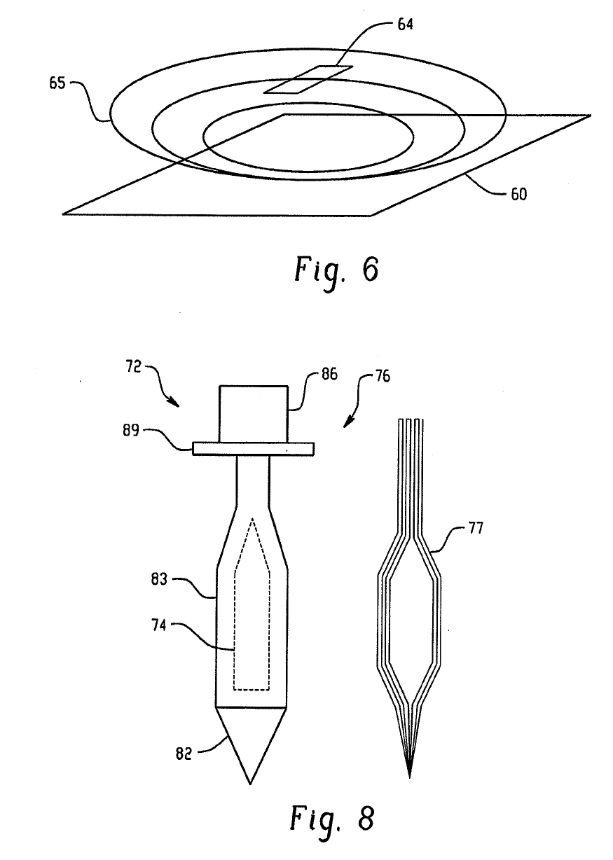

Referring also to FIG. 6, energy to transmit and sense temperature is obtained by the tag 64 from an electromagnetic field 65 (e.g., a near-field RF signal) generated by the reader 58 using antenna 60 at predetermined intervals, for example, or upon request from an operator. Referring back to FIG. 4, the antenna 60 can be a square planar looped design (e.g., formed of copper wire) that is tuned with a variable capacitor to a desired resonant frequency.

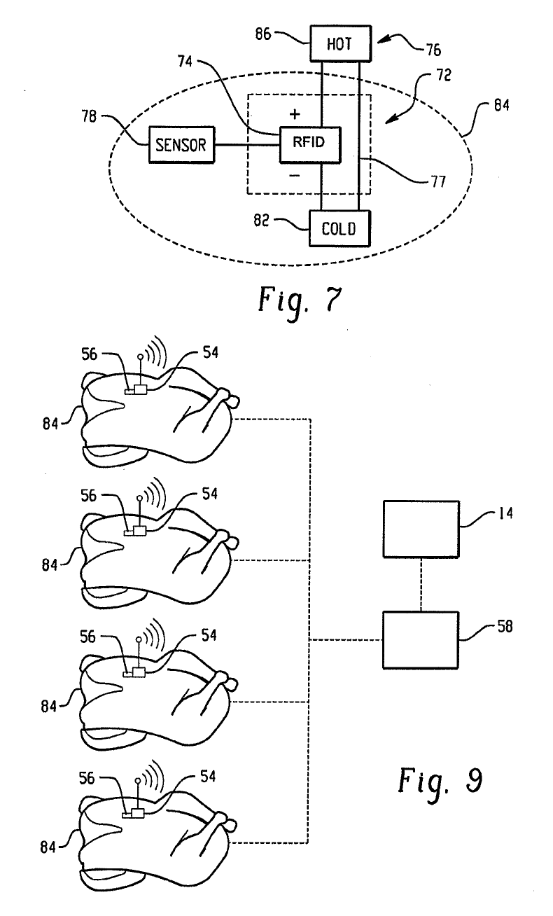

Referring to FIGS. 7 and 8, in another embodiment, a wireless transmitter 72 is incorporated into an tag 74 (including an active RF transmitter) that is powered by a thermobattery 76. The thermobattery 76 can be formed by a number of thermocouples 77 (e.g., formed of Type E thermocouples) connected together to develop a drive potential from the sum of the individual potentials. A temperature sensor 78 provides a signal to the tag 74 indicative of temperature within the food product. Food product temperature may be sampled by the temperature sensor at any suitable rate, such as every minute, every second, 10 times a second, etc. The tag 74 can send all or only some of the temperature indicative signals generated based on input from the temperature sensor 78 to the reader 58 using power from the thermobattery 76. In some embodiments, the tag 74 may include memory for storing a number of temperature indicative signals.

The thermobattery 76 includes a cold sink 82 that is inserted into the food product 84 and a hot sink 86 that is exposed to the oven's ambient temperature within the heating chamber 36 thereby creating a temperature gradient for operation of the thermobattery with an insulated portion 83 extending therebetween. The hot and cold sinks may be constructed of any suitable insulating material such as epoxy or silicone and permit the hot and cold ends of the thermopile to be coupled to the external environment. In some instances, a maximum temperature within the food product may be 185° F., while a maximum temperature within the heating chamber may be 400° F., thereby providing a temperature gradient for battery operation throughout the cooking cycle. Additionally, placement of the tag 74 within the food product provides some insulation from the higher temperatures outside the food product within the heating chamber 36. An outwardly extending stop 89 is provided for inhibiting the hot sink from entering the food product 84.

Referring back to FIG. 4, the reader 58 includes an oven control system 87 including a processor 88 and a storage component 90 (e.g., including random access memory). In some embodiments, the reader 58 may be part of a computer with the antenna 60 connected thereto. The processor 88 includes logic that converts the signals received from the wireless transmitter 54 (e.g., the tags 64 or 74) into a temperature value. In some embodiments, the processor 88 may also associate a timestamp with the temperature value and save the temperature value and timestamp in the storage component 90, for example, to create a log of temperature values.

The food product temperature values determined using the temperature sensor may be displayed to an operator on display 16 (FIG. 1). As another example, the food product temperature values may be conveyed to the operator using different methods and systems, such as via a text message, e-mail, phone message, remote display such as over the Internet on a remotely connected computer, etc. The operator can then know when the food product has or has not reached a desired temperature and may adjust oven temperature manually, if desired, using the control interface 14 (FIG. 1), over the phone, return text message, remote computer control, etc.

In some embodiments, the rotisserie oven 12 including oven control system 87 may utilize the temperature values to follow a recipe for cooking the food product saved in memory. For example, the rotisserie oven 12 including oven control system 87 may automatically adjust its cooking temperature upward or downward based on a measured food product temperature and target temperature based on recipe instructions. Such a recipe may be provided to the rotisserie oven 12 by the manufacturer or the operator. As another example, a recipe may be downloaded to memory over the Internet or provided to the oven by any other suitable process such as using a diskette, EPROM (such as a FLASH memory drive), etc.

Referring to FIG. 9, the operator may place a wireless transmitter 54 and temperature sensor 56 in a number of food products 84 to provide an even sample distribution. The reader 58 can then obtain temperature indicative signals from each of the wireless transmitters 54 based on measurements taken by the temperature sensors 56. In some embodiments, the wireless transmitters 54 may also transmit a unique identifier (e.g., using a RFID tag whether passive or active), which can be used by the operator to identify a specific food product or transmitter/sensor. For example, the control interface 14 may allow the operator to cycle through temperature values provided by each transmitter 54 to view temperatures for each food product in which a temperature sensor 56 has been placed. An irregular temperature reading might indicate an overcooked or undercooked food product or that the particular temperature sensor/transmitter is not operating properly. In some embodiments, the oven 12 automatically monitors each temperature value and displays an average temperature value (or some other predetermined value such as median temperature) to the operator. If one or more of the measured values fall outside a predetermined temperature range, the oven 12 may display a message to the operator indicating this.

The above-described automatic temperature measurement acquisition system 52 can provide a number of advantages. The transmitters 54 communicate wirelessly with the reader 58 which allows the rotisserie rotor 26 to rotate freely without interference with any wired connections between the temperature sensors and reader. The components forming the wireless transmitters 54 and sensors 56 can be formed of and/or encased or otherwise housed within food grade materials that can be washed and reused repeatedly and that can withstand temperatures within the heating chamber 26 during cooking operations. The automatic temperature measurement acquisition system 52 can allow real time monitoring of food product cooking temperatures which can be used to manually or automatically adjust cooking temperatures, for example, based on a programmed recipe or based on operator experience.

It is to be clearly understood that the above description is intended by way of illustration and example only and is not intended to be taken by way of limitation, and that changes and modifications are possible. For example, the automatic temperature measurement acquisition system 52 may be used with other oven types. Accordingly, other embodiments are contemplated and modifications and changes could be made without departing from the scope of this application.

What is claimed is:

1. An oven, comprising:
a housing including a heating chamber;
a door having an open position for allowing operator access to the heating chamber and a closed position for preventing user access to the heating chamber;
a heating system for heating a food product located within the heating chamber;
a wireless temperature sensor configured to be inserted into the food product by an operator for measuring food product temperature and to provide a wireless signal indicative of food product temperature;
an oven control system including a sensor communicator for receiving the temperature indicative signal from the wireless temperature sensor, the oven control system operating in response to the wireless signal.

2. The oven of claim 1 wherein the wireless temperature sensor is an active component and includes:
a wireless transmitter that transmits the temperature indicative signal;
a thermobattery providing power to the wireless transmitter and including a hot sink for positioning external of the food product and a cold sink for positioning internal of the food product.

3. The oven of claim 2 wherein the wireless temperature sensor includes a thermally insulated portion extending between the hot sink and the cold sink, the wireless transmitter located within the thermally insulated portion.

4. The oven of claim 3 wherein the temperature sensor includes an outwardly extending stop located adjacent the hot sink for preventing the hot sink from entering the food product.

5. The oven of claim 2 wherein the thermobattery comprises a plurality of thermopiles, each thermopile having one end connected with the hot sink and an opposite end connected with the cold sink.

6. The oven of claim 1 wherein the wireless temperature sensor is passive component and includes:
a resonant circuit including a temperature sensitive component located toward a probe end of the wireless temperature sensor such that a resonant frequency of the circuit varies with temperature of the food product.

7. The oven of claim 6 wherein the sensor communicator includes a loop antenna located for inductively coupling with the resonant circuit of the wireless temperature sensor and sensing a feedback resonance of the resonant circuit.

8. The oven of claim 7 wherein the loop antenna is located on or proximate to the door of the oven.

9. The oven of claim 1 wherein the oven control system operates in response to the wireless signal by displaying a temperature indication on a user interface.

10. The oven of claim 1 wherein the oven control system operates in response to the wireless signal by saving an indicated temperature value in memory.

11. The oven of claim 1 wherein the oven control system operates in response to the wireless signal by adjusting or varying oven operating conditions based upon the wireless signal.

12. The oven of claim 1 wherein the wireless temperature sensor is a first wireless temperature sensor, the oven further includes at least a second wireless temperature sensor and a third wireless temperature sensor, each of the first, second and third wireless temperature sensors includes a respective RFID tag uniquely identifying the wireless temperature sensors for communication with the oven control system.

13. A wireless temperature sensor for use in ovens, the wireless temperature sensor comprising:
a probe end and an opposite end;
a wireless transmitter that transmits a temperature indicative signal;
a thermobattery providing power to the wireless transmitter and including a cold sink at or proximate to the probe end and a hot sink positioned at or proximate to the opposite end.

14. The wireless temperature sensor of claim 13, including a thermally insulated portion extending between the hot sink and the cold sink, the wireless transmitter located within the thermally insulated portion.

15. The wireless temperature sensor of claim 14 wherein the temperature sensor includes an outwardly extending stop located adjacent the hot sink.

16. The wireless temperature sensor of claim 15 wherein the thermobattery comprises a plurality of thermopiles, each thermopile having one end connected with the hot sink and an opposite end connected with the cold sink.

17. A passive wireless temperature sensor, comprising:
a probe end and an opposite end;
a resonant circuit including a temperature sensitive component located toward a probe end of the wireless temperature sensor such that a resonant frequency of the circuit varies with temperature of the food product.

18. The passive wireless temperature sensor of claim 17, wherein the resonant circuit includes an inductor for coupling with a near-field RF signal.
